(19) United States
(12) Patent Application Publication
(10) Pub. No.: US 2004/0143499 A1
(43) Pub. Date: Jul. 22, 2004

(54) System and method for delivering plural advertisement information on a data network

(76) Inventors: Karl-Ludwig Dietsch, Munich (DE); Thierry Gros, Paris (FR); Andreas Pagel, Lausanne (CH); Krishna Balasubramanian, Fort Washington, PA (US); Dominique Barman, Fort Washington, PA (US)

Correspondence Address: JOHN W. RYAN, C/O DECHERT LLP, PRINCETON PIKE CORPORATION CENTER, P.O. BOX 5218, PRINCETON, NJ, 08543-5218, US

(21) Appl. No.: 10/746,967

(22) Filed: Dec. 24, 2003

Related U.S. Application Data
(63) Continuation of application No. 09/704,278, filed on Nov. 1, 2000, now abandoned.

(51) Int. Cl. G06F 17/60

(52) U.S. Cl. 705/14

(57) ABSTRACT

A preferred aspect of the invention concerns a system and method for serving plural resources on a data network. A first user request for resources is received from a user network processing device. At least one first server resource is transmitted to the user network processing device in response to the first user request for resources. The first server resource includes program code operable to format a single request for plural resources. The single request for plural resources is received and plural resources are transmitted to the user network processing device for presentation to the user.

### CROSS-REFERENCE TO RELATED APPLICATIONS

This application is a continuation of U.S. application Ser. No. 09/704,278, filed Nov. 1, 2000, and entitled “SYSTEM AND METHOD FOR DELIVERING PLURAL ADVERTISEMENT INFORMATION ON A DATA NETWORK”.

### FIELD OF THE INVENTION

The present invention relates to a system and method for delivering advertisement information via a data network.

### DESCRIPTION OF THE RELATED ART

In general, an Internet user accesses the World Wide Web (WWW or Web) using a network processing device such as personal computer and associated software including an operating system and Web Browser (e.g., Netscape Communicator, Microsoft Internet Explorer or the like). The Web Browser assists the user in identifying and/or inputting the network address of a given Web page or site. The address of a given Web site is generally formatted as a URL (Uniform Resource Locator), which is basically an advanced resource or file name formatted for Internet addressing. A URL typically points to a given resource such as an image or a file in a particular directory. The directory can exist on any machine on the Internet, and can be transmitted or served via one of many different protocols (e.g., HTTP, FTP, GOPHER, NEWS, NNTP, MAILTO and the like). However, typical World Wide Web documents are accessed using HTTP (Hyper-Text Transport Protocol).

A user can directly input the address of a given Web page into the address bar of the Web Browser (e.g., see FIG. 3D,); where “cpl” is the second level domain name and “com” is the top level domain of the requested Web site. In the alternative, the user can select a Web site from a pre-stored list of frequently visited sites (e.g., favorites or bookmarks). The user may also click on a Hyper-Text link embedded in a Web page (e.g., based on results returned from a typical search engine) or any other “Web-enabled” application (e.g., e-mail reader, news reader, word processor or the like) which contains a link to the desired site.

When an Internet user requests information from an Internet Web site, the Browser, via HTTP protocol, opens a connection and sends a request message to the desired Web server; the server then returns a response message, usually containing the resource (e.g., an HTML document) that was requested. After delivering the response, the server closes the connection. Often, the requested information arrives with several embedded HTML tags for advertisement information. These tags may refer to local resources (e.g., residing within the Web server domain). However, many Web sites do not store local advertisement information. Rather, they subscribe to a third party advertisement service (Advertisement Service) that place ads for them. An Advertisement Service typically serves advertisements for numerous advertisers.

Assuming an Advertisement Service is used, advertisement information is transmitted to the user via an HTTP call to the third party advertisement server. When a typical Web page is requested, it is assembled through many HTTP requests by the user's Web Browser. First, there is a request for the HTML itself. Then, the user's Browser requests everything the Browser needs to build the page, including images, advertisement information for various page positions, sounds, and plugins. The call to the third party advertisement server for advertisement information is typically an HTTP request for an image and is associated with a link to the advertiser's Web site. For example, the following HTML code fragment will present a typical “banner ad” (adl.gif) to the user with its associated link to an advertiser (e.g., see FIG. 3E). In this example, the image is served from a third party advertisement service located at adl.com, as shown in FIG. 3A.

The Advertisement Service generally selects and serves the proper advertisement for a given page position and collects advertisement statistics relating to the performance of a given advertisement campaign. For example, the number of times the particular advertisement information is sent to a given user, the URL of the referring Web site, the number of times the user responds positively to the advertisement information (e.g., click throughs) as well as other information.

The Advertisement Service Web server can tag or mark a user visiting its Web site for advertisement information. This is commonly achieved by storing “state” information called a cookie on the user's PC associated with the Web Browser. In its basic form, a cookie contains an ID which is uniquely associated with the user and/or the user's Web Browser and is associated with a particular domain (i.e., the domain of the authoring Web site such as a third party advertisement service). Cookies typically contain various information stored in “name=value” paired format (e.g., ID=123, Domain=cp.com, Age=37 and the like).

Cookies can be written and read via variety of methods. However, in general, when a Web server sends a user a Web page it also sends header information that the user's Browser records but does not display. Upon a first visit to a given Web site a Set-Cookie header is sometimes included with the Web page HTML. The Set-Cookie header specifies the “state” information that the Web site server wishes the user's Web Browser to record. When the user's Web Browser requests a page it also sends a variety of headers, specifying information such as the graphics formats it understands and the like. If a cookie has previously been set by a Web site that matches the desired URL, the user's Web Browser adds a Cookie header quoting back the previously stored information.

Cookies can store database information, custom page settings, or just about anything that would make a site individual and customizable. For example, a cookie can contain an anonymous code given to the user so the Web site operator can see how many users return at a later time.

Once the HTTP request is made, the third party advertisement server typically returns an advertisement and a cookie (e.g., ID=123, Domain=asl.com). Or, if the third party advertisement server has previously written a cookie to the user, it receives the user's cookie with the HTTP request, reads the cookie and may use the information contained in the cookie along with other information to determine what advertisement to return in the response. The net result is that the user gets a cookie from the third party advertisement server without directly instructing the Browser to visit the third party Web site or domain.

The underlying “advertisement related” communication and processing described above is carried out automatically by and between the user's Web browser, the advertisement servers and Web sites accessed by the user's Web browser. The majority of advertisement related communication and processing is essentially unknown to the user. However, the user often perceives delays in the load time of Web pages and the presentation or display of associated advertisement information. What is needed in the art, and provided by the invention, are improved systems and methods for delivering advertisement information via a data network such as the Internet.

### BRIEF SUMMARY OF THE INVENTION

The invention relates to a system and method for delivering resources on a data network data. In a preferred aspect the invention concerns a system and method for serving plural resources on a data network by transmitting plural resources in response to a single request for plural resources. In a preferred embodiment, the invention includes program code (e.g., Java™ code or JavaScript™) operable to format the single request for plural resources.

A preferred aspect of the invention concerns a system and method for serving plural resources on a data network wherein a first user request for resources is received from a user network processing device. At least one first server resource is transmitted to the user network processing device in response to the first user request for resources. The first server resource includes program code operable to format a single request for plural resources. The single request for plural resources is received and plural resources are transmitted to the user network processing device for presentation to the user.

In a preferred aspect of the invention, the plural resources are advertisement resources. In the context of the Internet, the advertisement resources including but not limited to Rich Media, HTML creatives, graphic images, banner ads, audio data and video data.

### BRIEF DESCRIPTION OF THE DRAWINGS

These and other features, aspects and advantages of the present invention will become better understood with regard to the following description, appended claims, and accompanying drawings where:

FIG. 1 is a general block diagram showing a user PC, content provider server, third party advertisement server and advertiser server in data communication in accordance with the invention;

FIG. 2 is a flow chart showing the basic communication between a user PC, content provider server, and third party advertisement server accordance with the invention;

FIGS. 3A-3E show various example links referred to in the description;

FIG. 4 shows exemplary code sections of an embodiment of the present invention; and

FIG. 5 shows additional exemplary code sections for an embodiment of the present invention.

### DETAILED DESCRIPTION OF THE INVENTION

Definitions

The following terms shall have, for the purposes of this application, the respective meanings set forth below.

Applet: generally refers to a program designed to be executed from within another application. For example, many Web browsers are equipped with Java virtual machines and can execute Java applets received from remote Web servers. Applets are typically small in file size and compatible with various platforms.

Database: generally refers to a collection of information stored for later retrieval. Traditional databases are organized by fields, records, and files. A field is a single piece of information; a record is one complete set of fields; and a file is a collection of records. The term “database” is used herein in its broadest sense (i.e., a collection of information) and is not limited to any particular structure or implementation.

Data network: generally refers to a group of two or more computer systems linked together in data communication. The term “data network” encompasses any type of wired or wireless computer network, independent of protocol, including local-area networks (LANs), wide-area networks (WANs) and networks of networks including the an intranet, extranet and the Internet.

HTML: is an acronym for Hyper-Text Markup Language, the authoring language used to create documents on the World Wide Web. HTML defines the structure and layout of a Web document by using a variety of tags and attributes.

Java: is a high-level programming language developed by Sun Microsystems. Java is an object-oriented language similar to C++, but simplified to eliminate language features that cause common programming errors. Java source code files (files with a java extension) are compiled into a format called bytecode (files with a class extension), which can then be executed by a Java interpreter.

JavaScript: is a scripting language developed by Netscape to enable Web authors to design interactive sites. Although it shares many of the features and structures of the full Java language, it was developed independently.

Rich Media: refers to Internet advertisements or banners containing anything including an image file. Rich Media types include Shockwave, Flash or Java banners, as well as various other lesser-known types of media, and HTML elements including but not limited to frames, iframes, layers and ilayers which allow inclusion of external objects including other HTML documents into a Web page.

Network processing device: generally refers to a network processing location or node. A network processing device includes but is not limited to a computer (such as a PC) portable or hand held computer device, other network enabled device (such as a Browser phone), or some other device, such as a printer. Each network processing device is typically assigned a unique static or dynamically assigned network address.

Resource: generally refers to data or software item that can be used on a network. The term as it is recited herein primarily refers to data, pointers to data, routines or pointers to routines that are available to network processing devices such as network servers, peers and/or clients (i.e., Web Browsers) and the like. Typical resources include files such as text files, graphics files and HTML files.

Server: generally refers to a program running on a computer that provides some service to other (e.g., client) programs.

It is understood that all references to Internet domain names such as cpl.com, asl.com, adl.com and the like are used herein for illustrative purposes only. These domain names have no correlation to any individual or business entity with an identical or similar Internet domain name previously or currently in use on the Internet or any individual or business entity adopting an identical or similar Internet domain name in the future.

The invention concerns a data network communication system and method for presenting resources to a user. The terms “present” or “presenting” as used herein are used in their ordinary sense and include displaying or playing audio and/or visual information to a user. The data network generally includes a plurality of nodes such as a user network processing device, content provider server, advertisement server, and an advertiser server coupled in data communication. The term “coupled” as recited herein is used in its broadest sense and does not require a physical connection between devices. Two or more devices as disclosed herein are “coupled” so long as data communication between the devices is possible (e.g., hard wired data communication, wireless data communications and the like).

In the context of the Internet, many types of network servers are available to provide resources to a user such as those for Network File System, Network Information Service (NIS), Domain Name System (DNS), FTP, news, finger, Network Time Protocol. The connection between two network nodes or a client and server is normally by means of message passing, over the data network, and uses some protocol (such as TCP/IP) to encode the client's requests and the server's responses. Typical servers may run continuously (as a daemon), waiting for requests to arrive or may be invoked by some higher level daemon which controls a number of specific servers.

The term “user network processing device” generally refers to any user operable device having access to the data network including but not limited to a personal computer (portable or desktop), personal digital assistant (PDA), Browser phone, 2-way pager or the like. The user network processing device can be operated by an individual or may be programmed to operate automatically (i.e., timed schedule or triggered by an external event). Thus, the term “user” as recited herein encompasses an individual as well as a computerized device operable to access the data network and perform computer automated functions.

In the context of the Internet, the user network processing device, content provider server, advertisement server and advertiser server all communicate via TCP/IP protocol (Transmission Control Protocol over Internet Protocol). Each is network addressable in that it has a specific IP address (i.e., the 32-bit address defined by the Internet Protocol usually represented in dotted decimal notation) which is used to route data between the devices. Web servers, advertisement servers and the like are preferably coupled to the Internet via high speed access methods (e.g., TI (1.544 Mbps), T3 (44.736 Mbps), OC-3c (155 Mbps), OC-12c (622 Mbps) and the like) so that maximum network performance is maintained.

The user network processing device is operable to transmit a plurality of user requests for resources and present the resources served in response to the user. The content provider server (first server) is operable to receive a first user request for resources and transmit a content provider server resource to the user network processing device in response. The advertisement server (second server) is operable to receive a second user request for resources, generate and transmit an advertisement server resource (e.g., a pointer to an image) to the user network processing device.

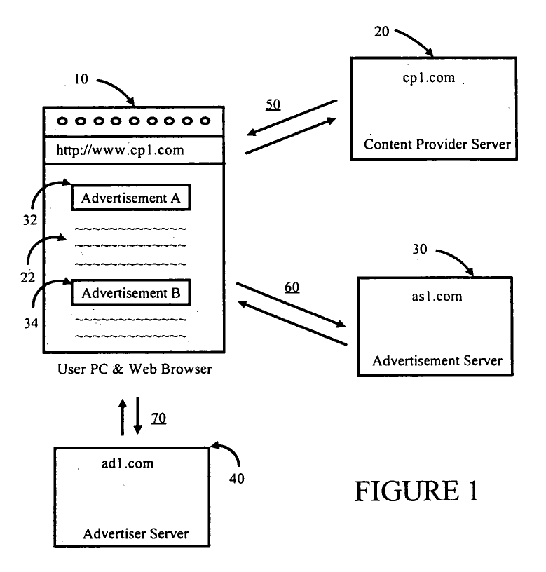

FIG. 1 shows a general block diagram of a user network processing device (user PC and Web Browser 10), content provider server 20, advertisement server 30 and advertiser server 40 in data communication via the Internet in accordance with the invention. FIG. 1 generally shows the data communications paths between the user PC and Web Browser 10, content provider server 20, advertisement server 30 and advertiser server 40 in loading a typical Web page containing advertisements 32 and 34 served by advertisement server 30 and content 22 server by content provider server 20.

Communications between user PC and Web Browser 10, content provider server 20, advertisement server 30 and advertiser servers 40, are generally shown by arrows 50, 60 and 70. It is understood that data communications via the Internet often traverse a series of intermediate network nodes prior to reaching the desired destination (e.g., the user or the first provider Web site). Arrows 50, 60 and 70 do not suggest a direct physical connection between the user PC and Web Browser 10 and/or various servers and encompass typical Internet communications (a connectionless, best-efforts packet based system). It is also understood that other data networks using various network protocols are suitable for use in accordance with the invention. It is further understood that multiple content provider servers, advertisement servers and advertiser servers can be combined without departing from the scope of the invention.

The user PC and Web Browser 10 is operable to access the Internet World Wide Web (WWW or Web). The user PC preferably has an associated operating system such as Microsoft Windows™ or Linux™ and includes a typical Web browser such as Netscape™ Communicator (for Windows™ or Linux™) or Microsoft Internet Explorer™, as well as numerous others. The Web browser assists the user in requesting and displaying Web pages or sites containing desired information. The hardware and software configuration of a user network processing device for Internet access is routine and generally known to those skilled in the art.

The content provider server 20 and advertiser server 40 are preferably HTML servers hosting a Web site (e.g., cpl.com, adl.com). There are many varieties of commercially or publicly available World Wide Web server software packages which are compatible with the invention (e.g., Apache, IBM™ WebSphere products, NETSCAPE™ Enterprise, Microsoft™ Windows IIS Server and the like) all of which can be implemented with commonly available hardware from vendors such as IBM, Hewlett Packard, Compaq, Dell, Sun and numerous others that are known to those skilled in the art.

Preferably, the content provider server is associated with an Internet Web having a web page ultimately including two or more advertisement resources associated with one or more advertisers. Each advertiser will typically have its own Web site that can be accessed by the user in response to the advertisement resources presented or displayed by the user's Web Browser (e.g., via an HTML link to the advertiser's Web site).

The advertisement server 30 is also preferably an HTML server operable to serve or transmit plural advertisement resources in response to requests for resources. The advertisement server is operable to transmit advertisement resources to a user for presentation as part of a Web page. Typical advertisement resources include, but are not limited to, Rich Media, HTML text and/or graphic elements or creatives, graphic images, banner ads, audio data, video data and the like. The advertisement server can be maintained by the content provider (e.g., located within the domain of the content provider) or a separate advertisement service or the like which assists one or more advertisers in publicizing various goods and/or services (e.g., outside of the domain of the content provider).

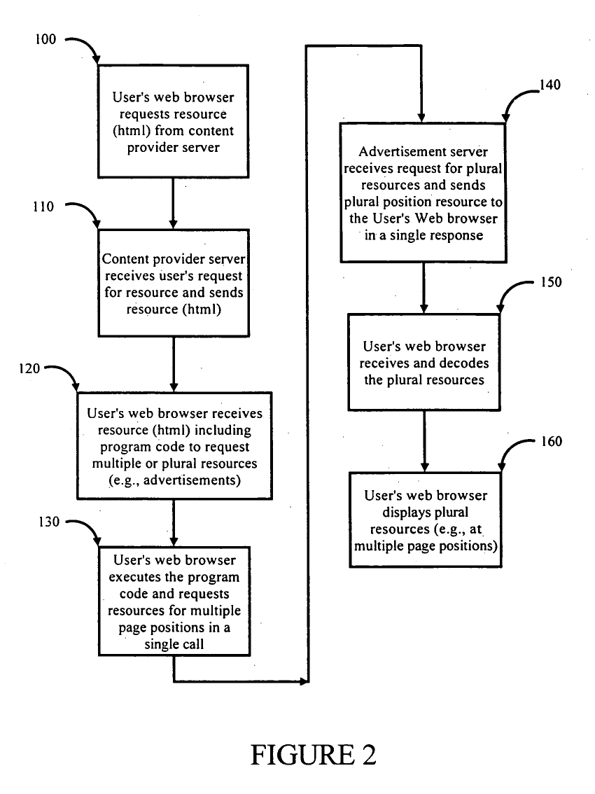

Operation of a system and method in accordance with the invention is best understood with reference to FIGS. 1 and 2. In general, the foregoing example outlines communications involved in a user accessing a Web site served from a content provider located at cpl.com. The user's Web sends a first user request for resources (e.g., an HTML document) to the content provider server. See FIG. 2, block 100. The first user request for resources will be accompanied by any cookie information associated with the user and the cpl.com domain as discussed briefly above (e.g., in an HTTP header).

The content provider server receives the user request for resources (and cookie if present) and returns a content provider resource (e.g., the HTML document from the cpl.com Web site). See FIG. 2, block 110. A Set-Cookie header may also be included with the content provider resource.

The user's Web Browser receives the content provider resource (i.e., the HTML document) and begins building the Web page for presentation (e.g., audio and/or visual) to the user. The content provider resource includes one or more embedded request for resources, namely advertisement resources ultimately served by the advertisement server 30. However, instead of serially requesting single advertisement resources from the advertisement server 30, the content provider resource includes program code or script based request for resources that is operable to request plural advertisement resources with a single request for resources (multiple page position request for resources). See FIG. 2, blocks 120 and 130.

The advertisement server receives the multiple page position request for resources and sends the requested plural advertisement resources (multiple page position resource) to the user's Web browser. See FIG. 2, block 140. The user's web browser receives the multiple page position resource and decodes (i.e., separates the received information into separate advertisement resources for different page positions). See FIG. 2, block 150. The user's web browser then displays or presents the advertisement resources. See FIG. 2, block 160.

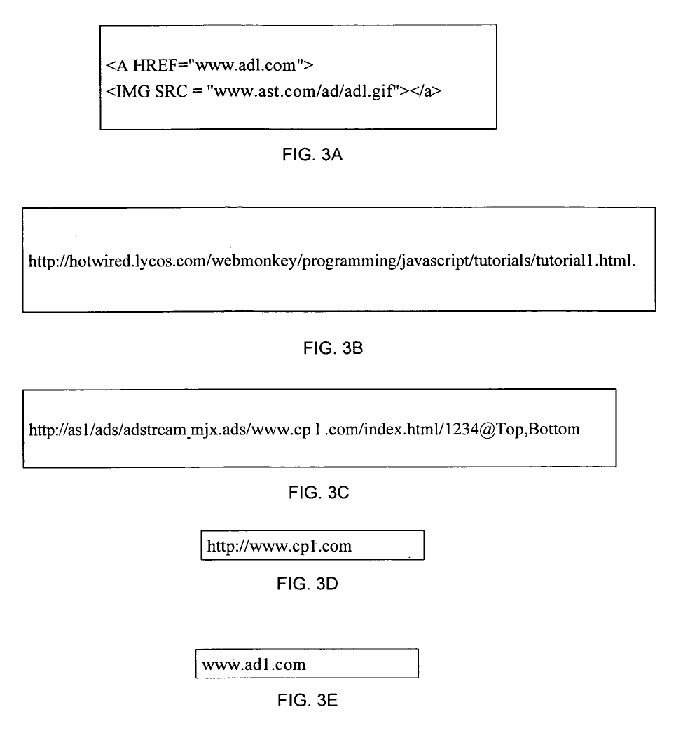

In a preferred embodiment, the invention is implemented using the JavaScript programming language. Information regarding JavaScript is available from numerous Internet Web sites including Thau's JavaScript Tutorial, for example, see the site given in FIG. 3B.

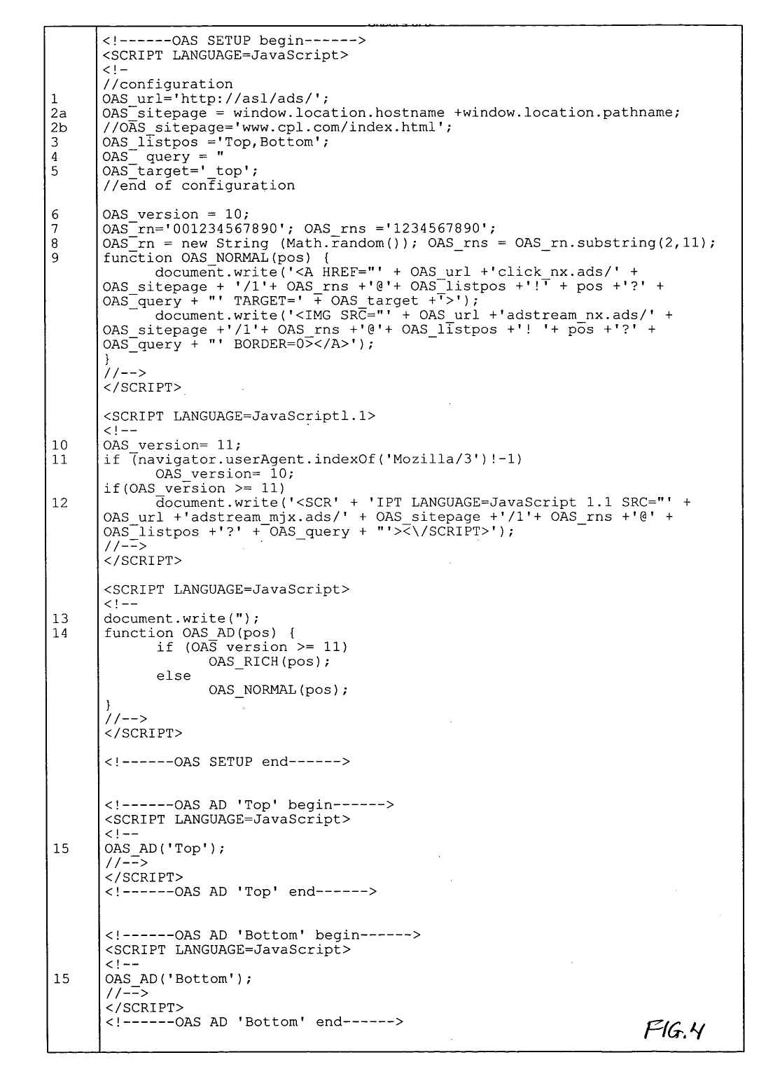

Most currently available user network processing devices include a browser (e.g., Netscape Communicator or Microsoft Internet Explorer) that supports the JavaScript programming language. An excerpt of a content provider resource including JavaScript program code operable to transmit a single request for plural advertisement resources is shown in FIG. 4, which has identified therein 15 exemplary code sections. It is understood that many programming languages are acceptable for use with the invention including but not limited to JavaScript, Java, Active X, VBScript and the like. It is also understood that the invention can be implemented using other programming constructs such as applets, plug-ins and the like.

Section 1 initializes the URL for the advertisement server.

Section 2 initializes the location of the content provider site/page. Section 2a is coded with the name of the current page (JavaScript function). In the alternative, the format shown in section 2b can be used, for a fixed site/page.

Section 3 initializes the list of page positions. In this case two positions are identified, top and bottom. The “top” position refers to a first position within the content provider web page for a first advertisement. The “bottom” position refers to a second position within the content provider web page for a second advertisement. It is also understood that advertisement resources can be positioned virtually anywhere within a given web page. It is also understood that additional positions can be identified so that requests for advertisements for three or more page positions are embedded within a single request to the advertisement server.

Section 4 initializes the query field used to pass query information to the advertisement server (e.g., user entered keywords and the like). This information can be used by the advertisement server in selecting appropriate advertisement content, campaigns, or information. Section 5 initializes the target to “top.”

Section 6 initializes the JavaScript version to 10.

Section 7 initializes the random number and section 8 calculates the random number.

Section 9 is a function OAS_NORMAL, which is called if the user's JavaScript version is less than version 1.1.

Sections 10 and 11 are used to determine whether user's Web browser has JavaScript version 1.1 or below.

Section 12 requests plural advertisement resources (i.e., the multiple page position resource). The call is done via the tag <SCRIPT SRC=. . . >. The result is that this line is replaced by a function JavaScript OAS_RICH(position) with the code for each page position. Section 13 provides compatibility for the Opera 4.01 browser. Section 14 is a function OAS_AD, used to test the version of JavaScript and call either the OAS_RICH or OAS_NORMAL function accordingly. Section 15 displays the banner for a single position.

Only a single call is made to advertisement server for all page positions. A sample call is shown in FIG. 3C

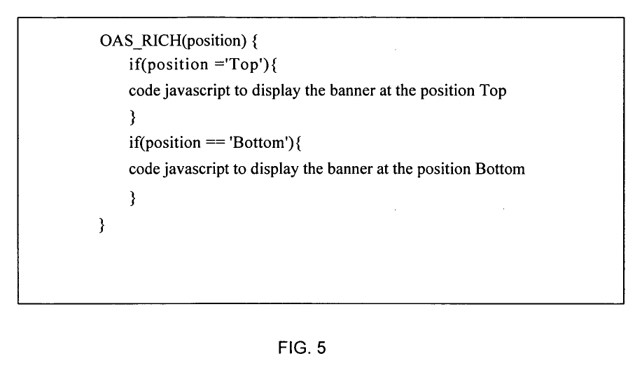

This call returns each Position—in this example, Top and Bottom—in a JavaScript function shown in FIG. 5.

For each position, there is a call to the function OAS AD. For example:

OAS_AD(‘Top’)

OAS_AD(‘Bottom’)

This function tests the version of JavaScript:

Version JavaScript >=11

OAS_RICH(position);

Version JavaScript <11

OAS_NORMAL(position).

In operation, the user's web browser requests a web page from the content provider server. The content provider server delivers the web page and the user's web browser renders the requested page. While rendering the delivered page, the visitor's web browser encounters JavaScript code that tests the visitor's browser for whether JavaScript is enabled and the version. According to the JavaScript decision, the browser then requests the appropriate ad(s) to be delivered from the advertisement server:

a. If the visitor's browser does not have JavaScript enabled, then the browser will not be able to display the ad.

b. If the visitor's browser does have JavaScript enabled, and the JavaScript test reveals that it is an older browser, then the browser will make multiple calls for the multiple positions requested, delivering an image such as a GIF or JPEG banner.

c. If the visitor's browser does have JavaScript enabled, and the JavaScript test reveals that it is a newer browser capable of HTML delivery, then the browser will make one call for all multiple positions request, delivering the advertisement resources (e.g., Rich Media, HTML creatives and the like) in multiple positions from the advertisement server. This HTML can be in the form of complete HTML creatives, or a set of ad tags (HTML replacement) that will make the final remote call for the creatives.

The appropriate ads are delivered and the browser renders them with the page. If an HTML creative is requested, the browser will preferably download it without opening a new browser window.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed is:

1. A method of providing advertising for a Website, the method comprising:
sending a request from a client system browser to a Web site for a document from a content provider, the document having a plurality of advertisement positions;
receiving the requested document from the Web site, the requested document including main program code configured to construct, by means of a single call, position program code in each of the plurality of advertisement positions in the requested document;
executing the main program code to construct the position program code in each of the plurality of advertisement positions;
executing the position program code in each of the plurality of advertisement positions to obtain an advertisement for each position;
receiving each advertisement from an advertisement server; and
displaying each advertisement in the requested document.

2. A method of providing advertising for a Website as recited in claim 1, wherein the main program code is JavaScript.

3. A method of providing advertising for a Website as recited in claim 1, wherein the advertisement in at least one of the advertisement positions is an HTML creative.

4. A method of providing advertising for a Website as recited in claim 1, wherein the advertisement in at least one of the advertisement positions is a set of ad tags, which when executed, obtain one or more HTML creatives.

5. A method of providing advertising for a Website as recited in claim 1,
further comprising,
prior to executing the main program code, determining whether the client system browser is JavaScript enabled; and
executing a single call to obtain the position program code for each advertisement position if the client system browser is not JavaScript enabled; and
wherein the step of executing the main program code occurs only if the client system browser is JavaScript enabled.

6. A content provider server for providing advertising, comprising:
a server connected to the Internet and configured to deliver a document having a plurality of advertisement positions to a client system connected to the Internet; and
a storage device, connected to the server, the storage device containing documents with main program code configured to construct, by means of a single call, position program code in each of the plurality of advertisement positions, the position program code configured, when executed by a client system, to obtain an advertisement for each position in the document.
